(19) United States
(12) Patent Application Publication
(10) Pub. No.: US 2012/0003574 A1
(43) Pub. Date: Jan. 5, 2012

(54) ELECTROPHOTOGRAPHY PHOTORECEPTOR, METHOD OF MANUFACTURING THE SAME, AND ELECTROPHOTOGRAPHY DEVICE USING THE SAME

(75) Inventors: Seizo Kitagawa, Nagano (JP); Yoichi Nakamura, Nagano (JP); Hiroshi Emori, Nagano (JP); Yasushi Tanaka, Nagano (JP); Hiroyuki Ichiyanagi, Nagano (JP)

(73) Assignee: FUJI ELECTRIC SYSTEMS CO., LTD., Tokyo (JP)

(21) Appl. No.: 12/735,860

(22) PCT Filed: Feb. 17, 2009
(86) PCT No.: PCT/JP2009/052620

§ 371 Date: Dec. 7, 2010

(30) Foreign Application Priority Data
Feb. 22, 2008 (JP) 2008-042052

(51) Int. Cl. G03G 15/00

(52) U.S. Cl. 430/56; 399/159

(57) ABSTRACT

A positive-charging electrophotography photoreceptor includes a laminated structure having a conductive supporting member, a charge transport layer formed of at least a hole transport material and a first binder resin, and a charge generation layer formed of at least a charge generation material, hole transport material, electron transport material, and second binder resin. The charge transport layer is disposed between the conductive supporting member and the charge generation layer. The content of the charge generation material in the charge generation layer is in a range exceeding 0.7 wt % and less than 3.0 wt % of the charge generation layer.

### CROSS-REFERENCE TO RELATED APPLICATIONS

This application is the national phase of international application number PCT/JP2009/052620, filed on Feb. 17, 2009, and claims the benefit of priority of Japanese application 2008-042052, filed Feb. 22, 2008. The disclosures of the international application and the Japanese priority application are incorporated herein by reference.

### BACKGROUND OF THE INVENTION

This invention relates to an electrophotography photoreceptor with excellent charging characteristics and independent dot reproducibility, and which can be manufactured with optimum photosensitivity and can obtain optimal image quality, in an electrophotography device with a high-resolution and a high-speed positive charging system, as well as to a method of manufacturing such an electrophotography photoreceptor, and to an electrophotography device using such an electrophotography photoreceptor.

In the prior art, printers, fax machines, copy machines, and other image formation devices utilizing electrophotography methods have had a photoreceptor, which is an image carrier; a charging device, which uniformly charges the surface thereof; an exposure device, which writes an electrical image (electrostatic latent image) according to an image; a developer device, which creates a toner image by developing this latent image with toner; and, a transfer device which transfers the toner image onto transfer paper. In addition, a fixing device, which fuses the toner on the transfer paper to the transfer paper, is also provided.

In such an image formation device, the photoreceptor used differs depending on the device concept; at present, except for inorganic photoreceptors such as Se, a-Si and similar in large and fast equipment, organic photoreceptors (hereafter abbreviated “OPC”), in which organic pigments are dispersed in a resin, are widely used due to their excellent stability, low cost, and ease of use.

In contrast with the fact that inorganic photoreceptors are the positive-charging type, such OPCs are generally the negative-charging type. This is because whereas hole transport materials, having the hole transport function necessary for negative-charging OPCs, have been developed from long ago, electron transport materials having the satisfactory electron transport function necessary for positive-charging OPCs have not been developed.

In a negative-charging process for such negative-charging type OPCs, the amount of ozone generated by negative corona discharge is far greater, by a factor of approximately 10, than the positive type, and adverse effects on the photoreceptor, as well as adverse effects on the usage environment, are regarded as problems. Hence the amount of ozone generation is reduced by adopting contact charging methods such as roller charging and brush charging; but costs are prohibitive compared with positive-type non-contact charging methods, and in addition contamination of the charging member is unavoidable, reliability has been insufficient, the surface potential of the photoreceptor is uniformly low, and in other respects as well there have been disadvantageous aspects for improving image quality.

In order to resolve these problems, the application of positive charging OPCs is effective, hence high-performance positive-charging OPCs are being sought. In addition to the above-described advantages specific to positive-charging methods, positive-charging OPCs are also advantageous over negative-charging OPCs with respect to dot reproducibility (resolution performance, tone reproduction), and are being studied in various fields in which resolutions are being raised. As described below, such positive-charging OPCs are broadly divided into four types of layer configurations, and many OPCs of these types have been proposed.

As described in Patent Reference 1 and Patent Reference 2 (which are identified below), the first type is a function-separated type photoreceptor with a two-layer configuration (not considering whether an undercoating layer is present) in which are laminated in order, on a supporting member, a charge transport layer and a charge generation layer.

As in Patent Reference 3, Patent Reference 4, and Patent Reference 5, the second type is a function-separated type photoreceptor with a three-layer configuration (not considering whether an undercoating layer is present) in which a surface protective layer is layered on the above two-layer configuration.

As in Patent Reference 6 and Patent Reference 7, the third type is a function-separated type photoreceptor with a reverse-layered two-layer configuration (not considering whether an undercoating layer is present), in which, in the opposite order of the first type, the charge generation layer and the charge (electron) transport layer are laminated in order.

As in Patent Reference 8, the fourth type is a single-layer type photoreceptor, in which a charge generation material, hole transport material, and electron transport material are dispersed in the same layer.

Of these, detailed studies have been performed on the fourth type, single-layer type photoreceptors, and this is the only type which has been vigorously commercialized. A major reason for this is thought to be that a configuration is employed in which the hole transport material supplements the electron transport function of the electron transport material, the transport capacity of which is inferior to the hole transport function of the hole transport material. Because this is a dispersive type, carrier generation occurs even within the film, but the amount of carrier generation near the surface is large, and the electron transport distance may be small relative to the hole transport distance, and so it is thought that the electron transport capacity is not necessary to the same extent as the hole transport capacity.

Even in cases of occurrence within the film, electrons moving in a surface direction are captured by holes, in greater absolute numbers, moving from the opposite direction, so that the electron transport capacity is thought to be at a low level relative to the hole transport capacity. For this reason, compared with the other three types, adequate environmental stability and fatigue characteristics for practical purposes have been attained.

On the other hand, from the standpoint of dot reproducibility, there is the following difference between positive-charging OPCs and negative-charging OPCs.

A single-layer type positive-charging OPC is a dispersive-type photoreceptor in which the carrier generation function and transport function are provided in a single layer. Hence the position of carriers generated by exposure to light is comparatively close to the surface, and in particular the peripheral portion of the exposure beam (the edge portion of independent dots) has low light energy and is close to the surface. As a result, in the peripheral portions of dots, the charge closest to the surface is cancelled, and because the light energy is high in the center, carrier generation positions are deeper, and so reach the photoreceptor surface later. That is, charge at the surface from outside an independent dot disappears, and an electrostatic latent image which is faithful to the Gaussian distribution of a single dot is easily obtained.

On the other hand, in a layered-type negative-charging OPC, carrier generation positions are in a thin charge generation layer near the support member, and positions are deep. Carriers diffuse upon injection into the charge transport layer from within the charge generation layer, and when moving within the charge transport layer, it is thought that due to carriers at high densities (carriers closer to the center of the exposure beam), carriers at low densities on the outside are caused to diffuse to the outside. Further, in a negative-charging OPC, the mobility of carriers (holes) is higher than the mobility of carriers in a positive-charging OPC (electrons), and movement in lateral directions readily occurs, so that the peripheral portion of a single dot is thought to be easily broadened. Hence broadening of the electrostatic latent image of one dot is thought to be large compared with the Gaussian distribution of the exposure light.

Hence it is thought that in principle, a single-layer type positive-charging OPC has inherently superior characteristics for dot reproducibility, with respect to the mechanism of movement from carrier generation by exposure light.

However, with the faster speeds, higher resolutions, and introduction of color into devices in recent years, requirements with respect to independent dot reproducibility and tone reproduction have grown increasingly more strict. In particular, in color equipment, it is necessary to produce intermediate colors through color overlap of dots of each color, so that demands for dot reproducibility and tone reproduction are redoubled. In order to achieve excellent dot reproducibility, it is important that the photoreceptor be provided with sensitivity characteristics which are optimal for the development characteristics, which differ among devices.

And, as shown in FIG. 1, lowering of the surface potential of the photoreceptor in the region of low exposure energy (γ reduction) on the light attenuation curve is an effective means of raising the toner development efficiency for a single dot latent image.

However, as explained above, the positive-charging OPCs currently being commercialized are the types in which functional materials are dispersed in a single film, so that there are limits to sensitivity control accommodate the various sensitivities demanded by recent high-speed, high-resolution, color equipment. The reasons for this are explained below.

First, in single-layer positive-charging OPCs, functions for both carrier generation and for carrier transport are imparted to a single film, so that the film application process can be simplified, and there is the advantage that a high item pass rate and process efficiency can easily be obtained; on the other hand, there is the drawback that almost no control of sensitivity characteristics is possible.

However, in recent high-speed, high-resolution, color equipment and similar, there is a need to accommodate the various required sensitivities to realize excellent resolution performance, tone reproduction, and dot reproducibility. In order to accommodate such needs, photoreceptor manufacturers have to develop new materials and application liquids to selectively utilize charge generation materials, as described in Patent Reference 9. The development of such new items invite a decrease in manufacturing efficiency as it bolsters more resource consumption or increased use of application liquid. This being the case, it has been necessary for device manufacturers to employ a design that permits the incorporation to the photoreceptor, and this has provided the manufacturers with less latitude in device designing.

Secondly, as stated above, in order to reduce the γ of the light attenuation curve, raising the amount of carrier generation by increasing the amount of charge generation material added is effective, but in a single disperse film, side effects such as deterioration in dark decay characteristics and charging performance tend to appear, thus entailing cost disadvantages. Hence in a single-layer positive-charging OPC of the prior art, when optimizing compatibility with the device for installation, and in recent high-speed, high-resolution, color equipment, there has been the problem that there are limits to accommodation of higher image quality.

As explained above, only positive-charging types are being commercialized, and even among mass-produced single-layer type OPCs, there is the drawback that comparatively easy sensitivity control in negative-charging type OPCs is difficult to execute, and so there have been numerous studies of other layer configurations (layered-type positive-charging OPCs). However, various difficulties have not been fully resolved, as described below, and commercialization has not been achieved.

For example, as regards the first type, which is a two-layer lamination type, as described in Patent Reference 2 above, while there are stipulations regarding the materials employed in each of the layers, insufficient durability with respect to chemical attack and damage therefrom, and insufficient durability with respect to wear and other mechanical attack, are problems, as can be seen even in use of high-concentration charge generation materials in practical examples. In Patent Reference 2, the charge generation layer comprises charge transport material, so that in a practical example a 5 μm charge generation layer is provided; but overall, charge generation material is comprised in a high concentration, and in order to control sensitivity the material and composition ratio of the charge generation layer itself are changed. Hence there are problems with durability and characteristics, and commercialization has not been achieved.

In the three-layer lamination type which is the second type, in order to resolve drawbacks in the above two-layer lamination type, numerous studies continue to be conducted, and in Patent Reference 10 fine conductive particles are added to the surface protective layer to improve electron transport properties, while in Patent Reference 11 two or more layers are used as the surface protective layer; however, while the range of adjustment of the charge generation layer is broad and there is a strong possibility that a configuration with wide applicability is possible, a stage has not yet been reached in which a surface protective layer having adequate electron transport capacity and chemical and mechanical stability can be manufactured with excellent mass-production stability, and adequate performance has not yet been attained with respect to environmental stability, repetition stability, and image quality stability, so that commercialization has not yet been achieved.

With respect to the reverse-layered two-layer type which is the third type also, Patent Reference 12 uses an electron receptor material comprising an oversaturated absorption dye in the electron transport layer, and Patent Reference 13 uses an electron transport layer comprising a hole transport material; but the electron transport function of the electron transport layer does not equal the hole transport function of hole transport materials used in conventional negative-charging OPCs, sensitivity and optical response performance are not necessarily adequate, and commercialization has not been achieved.

Hence at present, conventional positive-charging OPCs capable of sensitivity control similar to that of negative-charging OPCs cannot be obtained, and so the advantage of the high-resolution performance inherent in positive-charging OPCs cannot be fully exploited.

With respect to OPC sensitivity adjustment, in addition to methods in which the film thickness of the charge generation layer is controlled, there are also a method of performing sensitivity control by changing the mixing ratio of phthalocyanine of the charge generation material (Patent Reference 14); a method of forming a separate sensitivity adjustment layer, and performing sensitivity adjustment by changing the film thickness thereof, without changing the film thickness or composition of the charge generation layer (Patent Reference 15); and, a method of controlling the light quantity dependence by changing the amount of silicon naphthalocyanine added to a protective layer (Patent Reference 16), and similar.
Patent Reference 1: Japanese Patent Publication No. H05-30262
Patent Reference 2: Japanese Patent Application Laid-open No. H04-242259
Patent Reference 3: Japanese Patent Publication No. H05-47822
Patent Reference 4: Japanese Patent Publication No. H05-12702
Patent Reference 5: Japanese Patent Application Laid-open No. H04-241359
Patent Reference 6: Japanese Patent Application Laid-open No. H05-45915
Patent Reference 7: Japanese Patent Application Laid-open No. H07-160017
Patent Reference 8: Japanese Patent Application Laid-open No. H03-256050
Patent Reference 9: Japanese Patent Application Laid-open No. H10-288849
Patent Reference 10: Japanese Patent Application Laid-open No. 2003-21921
Patent Reference 11: Japanese Patent Application Laid-open No. 2005-84623
Patent Reference 12: Japanese Patent Application Laid-open No. H11-160898
Patent Reference 13: Japanese Patent Application Laid-open No. 2005-121727
Patent Reference 14: Japanese Patent Application Laid-open No. H05-173345
Patent Reference 15: Japanese Patent Application Laid-open No. H07-28264
Patent Reference 16: Japanese Patent Application Laid-open No. H06-123993

### SUMMARY OF THE INVENTION

This invention was devised in light of the above problems, and has as objects the acquisition of an electrophotography photoreceptor and electrophotography device with excellent dot reproducibility and tone reproduction in positive-charging type high-speed, high-resolution color equipment, and the provision of an electrophotography photoreceptor which can achieve optimal sensitivity characteristics among different devices merely by adjustment of a film thickness ratio.

As a result of diligent studies in order to resolve the above problems, these inventors discovered that resolution could be achieved by means of the following configuration, and succeeded in completing this invention.

That is, this invention relates to an electrophotography photoreceptor of a laminate-type positive-charging having, on a conductive supporting member, a charge transport layer formed of at least a hole transport material and a first binder resin, and a charge generation layer formed of at least a charge generation material, a hole transport material, an electron transport material, and a second binder resin, which are laminated in order, wherein the content of the charge generation material in the charge generation layer is in a range exceeding 0.7 wt % and less than 3.0 wt % in this layer.

Further, this invention relates to an electrophotography photoreceptor in which with a surface protective layer not being formed, the charge generation layer serves as the uppermost surface layer.

Further, this invention relates to an electrophotography photoreceptor in which the content of the second binder resin in the charge generation layer is from 40 wt % to 70 wt %.

Further, this invention relates to an electrophotography photoreceptor in which the content of the first binder resin in the charge transport layer is from 40 wt % to 60 wt %. Also, in this electrophotography photoreceptor, the first binder resin is polystyrene.

Further, this invention relates to a method of manufacturing an electrophotography photoreceptor of laminate-type positive-charging having, on a conductive supporting member, a charge transport layer formed of at least a hole transport material and a first binder resin, and a charge generation layer formed of at least a charge generation material, a hole transport material, an electron transport material, and a second binder resin, which are laminated in order, wherein, the content of the charge generation material in the charge generation layer is in a range exceeding 0.7 wt % and less than 3.0 wt % in this layer, and a desired sensitivity is set by changing a relative ratio of the film thickness of the charge transport layer to the film thickness of the charge generation layer.

Further, this invention relates to a method of manufacturing an electrophotography photoreceptor in which the first binder resin of the charge transport layer is polystyrene, and the charge generation layer is fabricated on the charge transport layer by an immersion application method.

Further, this invention relates to an electrophotography device equipped with an electrophotography photoreceptor described above.

Further, an electrophotography device of this invention employs a nonmagnetic single-component contact development cleanerless process using a positive polymerized toner.

By means of this invention, in a positive-charging type electrophotography photoreceptor used in a high-resolution positive charging method, by providing a charge generation layer on a charge transport layer with an optimum film thickness ratio, the sensitivity characteristics and light attenuation curve are controlled, high image quality with excellent dot reproducibility and tone reproduction is obtained, and even when the required sensitivity differs among devices, the optimum image quality can be obtained using the same layer configuration merely by changing the film thickness ratio.

### BRIEF DESCRIPTION OF THE DRAWINGS

FIG. 1 is a graph showing the relation between exposure energy and surface potential;

FIG. 2A is a schematic cross-sectional view of a layered-type positive-charging electrophotography photoreceptor (no undercoating layer present) of one embodiment of the invention;

FIG. 2B is a schematic cross-sectional view of a layered-type positive-charging electrophotography photoreceptor (undercoating layer present) of another embodiment of the invention; and

FIG. 3 is a graph showing the relation between charge generation layer film thickness and exposed portion potential, in an experimental example.

### DESCRIPTION OF THE PREFERRED EMBODIMENTS

Below, specific practical examples of electrophotography photoreceptors of this invention are explained in detail using the drawings. This invention is not limited to the practical examples described below.

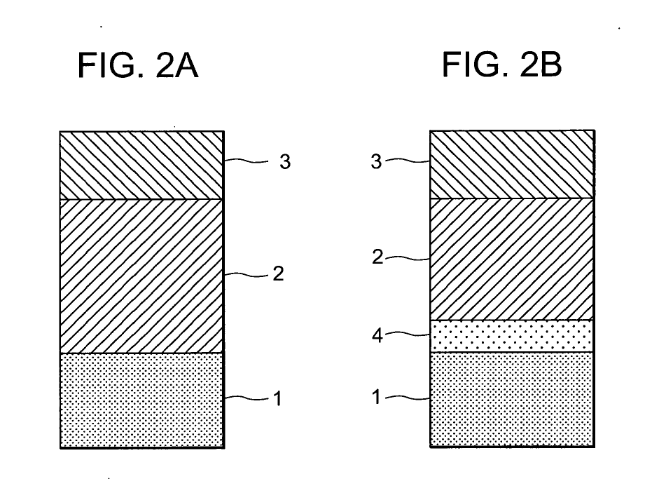

The electrophotography photoreceptor is a positive-charging layered-type electrophotography photoreceptor, in which at least a charge transport transport layer and a charge generation layer are laminated in order on a conductive support member. FIG. 2 is a schematic cross-sectional view showing the electrophotography photoreceptor of one practical example of the invention; on a conductive base 1 are layered, in order, a charge transport layer 2 comprising a charge transport function, and a charge generation layer 3 comprising charge generation and transport functions.

As shown in FIG. 2A, an undercoating layer need not be present, but when interference fringes tend to appear, an undercoating layer 4 may be provided as in FIG. 2B.

The conductive base 1 serves as one electrode of the photoreceptor, and at the same time is a support member for the layers comprised by the photoreceptor, and may be in cylinder form, plat form, film form, or similar shapes; as the material, aluminum, stainless steel, nickel, or another metal, as well as glass, resin, or similar with conductive treatment on the surface, may be used.

The undercoating layer 4 is not essential in this invention, but can be provided as necessary. Comprising a layer the main component of which is a resin, or alumite or another metal oxide film, an undercoating layer is provided as necessary with the purpose of improving closeness of adhesion of the conductive base and the charge transport layer, and to control charge injection performance into the photosensitive layer. Resin materials used in an undercoating layer include casein, polyvinyl alcohols, polyamides, melamine, cellulose, and other insulating polymers, and polythiophene, polypyrrole, polyaniline, and other conductive polymers; these resins can be used individually, or can be combined and mixed for use as appropriate. In addition, titanium dioxide, zinc oxide, or other metal oxides can be included in these resins.

The charge transport layer 2 principally comprises a hole transport material and a binder resin; the hole transport material used may be one of various hydrazine compounds, styryl compounds, diamine compounds, butadiene compounds, indole compounds, or similar, either independently, or appropriately combined and mixed for use; as the binder resin, a bis phenol A type, bis phenol Z type, bis phenol A type-biphenyl copolymer type, or other polycarbonate resin, a polyester resin, a polystyrene resin, a polyphenylene resin, or similar, either independently, or appropriately combined and mixed, is used; however, it is preferable that a resin be used which is not easily dissolved by the solvent of the charge generation layer which is the upper layer.

When using a seal coating method or a spray coating method, the effects of the solvent of the charge generation liquid are not readily felt, and so fabrication is also possible using generally and frequently used polycarbonate or polyester resins; however, mass producibility is poor.

As a result of numerous diligent studies, it was discovered that as the binder resin for the charge transport layer, by using a polystyrene resin, which generally had been thought to be unsuitable, dissolving of the charge transport layer can be suppressed and a film fabricated even when using an immersion application method, while securing solubility with the charge transport material.

A polystyrene resin has the problem of low mechanical strength compared with polycarbonate resins and polyether resins, but in this invention the resin is not used in the uppermost surface layer, and so use is possible.

A ratio of the binder resin in the charge transport layer in the range 25 wt % to 75 wt % is used. It is preferable that the range be 40 wt % to 60 wt %. If the binder resin content in the charge transport layer is greater than 60 wt %, that is, if the hole transport material content in the charge transport layer is less than 40 wt %, then in general the transport function is insufficient, and the remaining potential is high; in addition, the dependence on environment of exposed portion potentials in the device is increased, and environmental stability of image quality tends to be insufficient, and the device is not suitable for use. On the other hand, if the binder resin content in the charge transport layer is less than 40 wt %, then the mechanical strength decreases as the glass transition point is reduced, and in particular creep deformation due to pressure from the development roller, transfer roller, cleaning blade, and other contact members during high-temperature storage tends to occur, so that actual use is not possible.

The film thickness is decided in conjunction with the charge generation layer, described below, but from the standpoint of securing effective performance for practical use, a thickness in the range 1 μm to 40 μm is suitable, a thickness from 3 μm to 27 μm is preferable, and a thickness from 5 μm to 25 μm is still more preferable.

The charge generation layer 3 is formed by applying an application liquid, in which particles of charge generation material as described above are dispersed in a binder resin in which are dissolved a hole transport material and an electron transport material, or by a similar method. In addition to the function of receiving light and generating carriers, a function of transporting generated electrons to the photoreceptor surface, and of transporting holes to the above-described charge transport layer, is also performed. In addition to a high carrier generation efficiency, the property of injecting generated holes into the charge transport layer 2 is important, and it is desirable that the electric field dependence be small and that injection be satisfactory even for weak electric fields.

As the charge generation material, independent X-type metal-free phthalocyanine, or else α-type titanyl phthalocyanine, β-type titanyl phthalocyanine, Y-type titanyl phthalocyanine, γ-type titanyl phthalocyanine, or amorphous titanyl phthalocyanine, may be used either independently, or appropriately combined; and an appropriate material can be selected according to the light wavelength region of the exposure light source used in image formation.

As the hole transport material, materials used in the above-described charge transport layers can be employed, but due to the need to inject holes into the charge transport layer, it is desirable that the ionization potential difference be small, and it is preferable that the difference be within 0.5 ev.

As the electron transport material, a material with high mobility is desirable, and benzoquinone, stilbenequinone, naphthaquinone, diphenoquinone, phenanthraquinone, azoquinone, or other quinone system materials, are preferable. These can be used singly, but when higher sensitivity is necessary, it is desirable that two or more types be used, and that the content of the charge transport material be increased, while suppressing segregation.

As the binder resin used in the charge generation layer in order to cause dispersion of each of the above components, the binder resin of the above charge transport layer can be used. That is, a bis phenol A type, bis phenol Z type, bis phenol A type-biphenyl copolymer type, or other polycarbonate resin, a polyester resin, a polystyrene resin, a polyphenylene resin, or similar, either independently, or appropriately combined and mixed, can be used. Of these, a polycarbonate resin or polyester resin is preferable in consideration of the dispersion stability of the charge generation material, solubility with the hole transport material and electron transport material, mechanical stability, chemical stability, and thermal stability.

While explained below, the film thickness is decided in conjunction with the charge transport layer, and from the standpoint of securing effective performance for practical use, a thickness in the range 1 μm to 40 μm is suitable, a thickness from 3 μm to 27 μm is preferable, and a thickness from 5 μm to 25 μm is still more preferable.

The distribution amounts of each of the functional materials (charge generation material, electron transport material, and hole transport material) are set as follows.

First, in this invention, it is very important that the content of the charge generation material in the charge generation layer 3 be from 0.7 wt % to 3 wt % in the charge generation layer, and preferably from 1 wt % to 2.5 wt %. If this content is less than 1 wt %, the range of sensitivity control is limited (narrowed), and interference fringes tend to occur. On the other hand, if the content exceeds 2.5 wt %, it is difficult to adjust sensitivity by controlling the film thickness of the charge generation layer.

Next, the ratio of the binder resin in the charge generation layer is set, preferably in the range 30 wt % to 70 wt %, in order to obtain the desired characteristics; and more preferably the ratio is set in the range 40 wt % to 70 wt %. The remaining components in the charge generation layer are functional materials (the charge generation material, electron transport material, and hole transport material).

If the binder resin is less than 40 wt % of the charge generation layer, then the creep strength is insufficient due to a decline in the glass transition point, and creep deformation due to pressure from contact members tends to occur. Moreover, toner filming, and filming due to externally added materials and paper particles, readily occurs, and moreover solvent crack resistance to grease, skin oil, and similar is insufficient, resulting in unsuitability for practical use. On the other hand, if the binder resin is more than 70 wt % of the charge generation layer, that is, if the functional materials are less than 30 wt %, then there are concerns that it may be difficult to obtain the desired sensitivity characteristics even through film thickness control, resulting in unsuitability for practical use.

Hence the ratio of the charge generation material to charge transport materials (the sum of the hole transport material and the electron transport material) is set in the range 1:11 (2.5 wt %:27.5 wt %) to 1:59 (1 wt %:59 wt %). If the charge generation material ratio is too high, the sensitivity and light attenuation curve cannot be controlled through the film thickness ratio of the charge generation layer and the charge transport layer, and if too low, it is difficult to obtain the desired sensitivity.

The ratio of the electron transport material to the hole transport material can be varied in the range 1:4 to 4:1, according to the film thickness and sensitivity, but ratios of 2:3 to 3:2 are appropriate. If there is too little or too much electron transport material, the balance between electron transport and hole transport breaks down, the sensitivity declines, and memory image formation tends to occur.

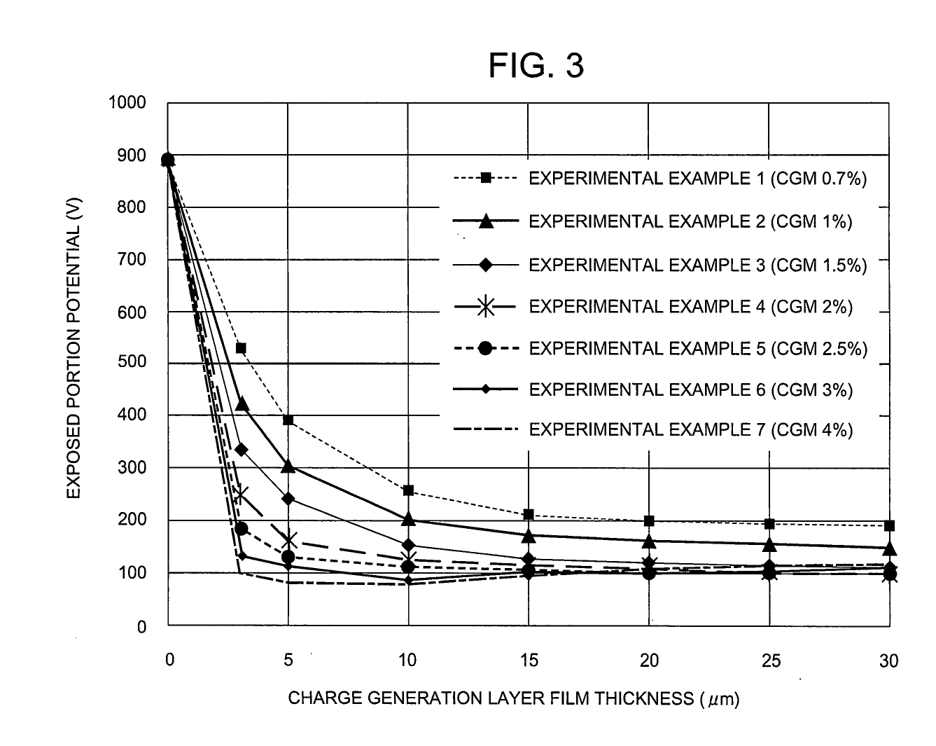

By means of this configuration of the invention, as shown in FIG. 3 presenting the results of the following practical example, by changing the film thickness of the charge generation layer, an arbitrary exposed portion potential (sensitivity characteristic) can be obtained.

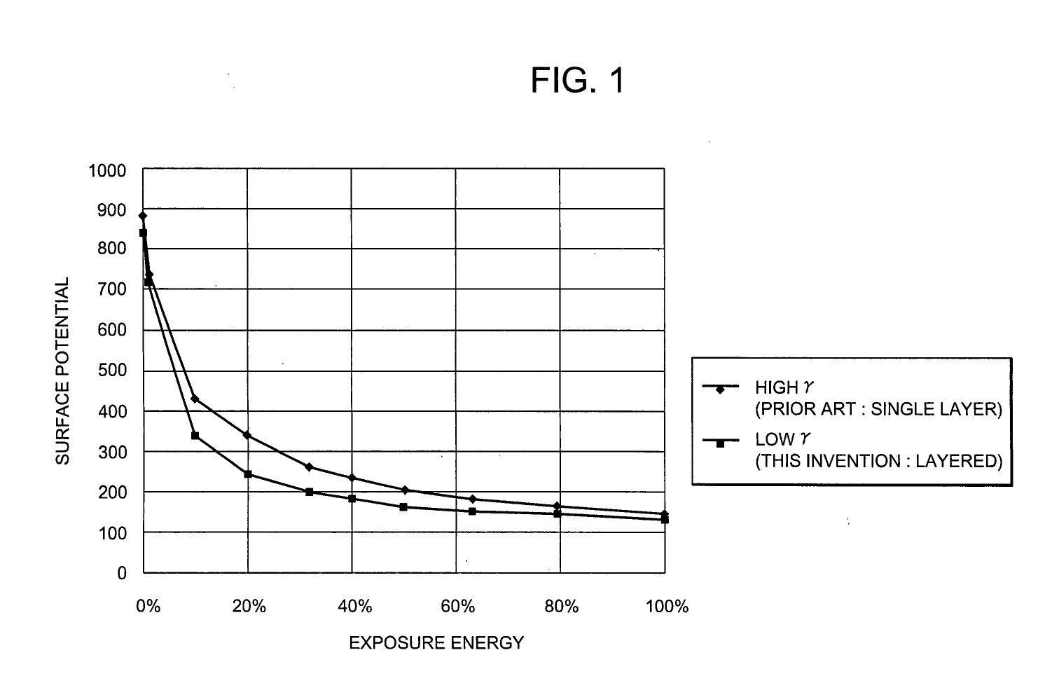

Further, as described above, by means of this configuration of the invention, the charge generation layer and the charge transport layer can be set separately, and the charge generation material used can be reduced. That is, a low γ can be obtained for the light attenuation curve for a single-layer type OPC as shown in FIG. 1 while securing charging performance, and characteristics with excellent dot reproducibility can be achieved.

On the other hand, when raising speeds through minor changes to a device, there is a limit to the light quantity setting, and so as a result of decreases in the energy of exposure light irradiating the photoreceptor it is necessary to lower the post-exposure potential with weaker optical energy even for the same photoreceptor, and so in conventional equipment, it is important to employ a photoreceptor with a large slope of the light attenuation curve (hereafter abbreviated to “γ index”) on the low-irradiation side, in order to secure image quality. However, in conventional single-layer positive-charging OPCs, the need arises to develop new photosensitive layer materials and compositions.

In the case of a layered-type positive-charging electrophotography photoreceptor of this invention, on the other hand, by adjusting the film thickness ratio of the charge generation layer and the charge transport layer, this γ index can be obtained, so that there is the characteristic of wide applicability, such that an optimal γ index for each device, that is, optimal light attenuation characteristics, can be realized.

An electrophotography photoreceptor of this invention can be appropriately manufactured by a method of manufacturing of electrophotography photoreceptors comprising a process of performing immersion application of a charge transport layer application liquid; a process of drying to obtain a charge transport layer; and, a process of performing immersion application of a charge generation layer application liquid onto the charge transport layer thus obtained and drying, to obtain a charge generation layer. At this time, by adjusting the viscosity of both the charge transport layer application liquid and the charge generation layer application liquid by means of the respective solvents, and by adjusting the lifting speed, the film thickness ratio of the charge generation layer 3 and the charge transport layer 2 can be adjusted. In this invention, by increasing the ratio of the charge generation layer as a fraction of the entire photoreceptor the exposure potential in the installed device is lowered, and as a result, the optimum γ index can be attained for each device.

An electrophotography photoreceptor of this invention can be appropriately installed in various electrophotography devices with different sensitivity requirements. In particular, advantageous results can be fully realized in an electrophotography device employing a nonmagnetic single-component contact development cleanerless process using a positive polymerized toner.

Practical Example

Below, a practical example of the invention is explained.

(Practical Example of Manufacture of Electrophotography Photoreceptor)

[Conductive Base]

An aluminum tube, cut and machined to a shape of 30 mm diameter×244.5 mm and surface roughness (Rmax) of 0.2, with a wall thickness of 0.75 mm, was used.

[Manufacture of Charge Transport Layer Application Liquid]

As the hole transport material (hereafter abbreviated to “HTM”), a styryl compound described below (HTM-A), and as the binder resin a polystyrene, “PS-680” (manufactured by PS Japan Corporation), were used, in amounts of 100 parts by weight each; these were dissolved in dichloromethane as the solvent, to prepare the charge transport layer application liquid. Polystyrene generally contains mineral oil, but when used in a binder resin for an OPC, tends to worsen the sensitivity characteristic. The polystyrene used in this invention on the other hand does not contain mineral oil, and was discovered to be suitable as a binding resin for OPCs. By appropriately evaporating the dichloromethane solvent and adjusting the dilution according to the film thickness of the charge transport layer to be formed, the viscosity was adjusted.

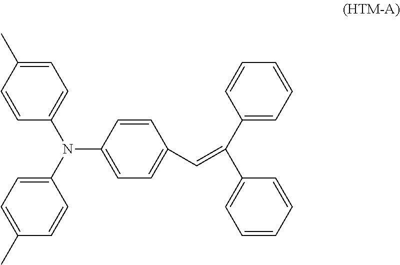

[Manufacture of Charge Generation Layer Application Liquid]

As the charge generation material (hereafter abbreviated as “CGM”), X-type metal-free phthalocyanine was used. As the HTM, the same HTM-A as in the charge transport layer was used. As the electron transport material (hereafter abbreviated as “ETM”), the ETM-B described below was used, and as the binder resin, polycarbonate “TS2050” (manufactured by Teijin Chemicals Ltd.) was used.

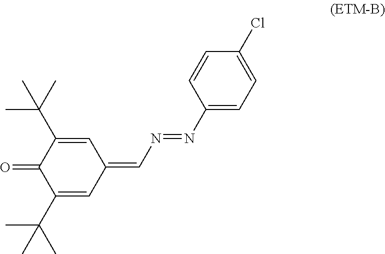

The amounts added to the charge generation layer were set at 25 wt % for HTM and 25 wt % for ETM, and the variable (as shown in Table 1, from 0.7 wt % to 4 wt %) CGM added amount and the binder resin added amount were taken to be 50 wt %; by dissolving in dichloromethane as the solvent, and dispersing at once using a ball mill, the charge generation layer application liquid was obtained. By appropriately evaporating the dichloromethane solvent and adjusting the dilution according to the film thickness of the charge transport layer to be formed, the viscosity was adjusted.

[Photoreceptor Manufacture]

After immersion application of the above charge transport layer application liquid, drying was performed for 1 hour at 130° C. in a drying furnace, to obtain the charge transport layer. Next, the above charge generation layer application liquid was applied by the immersion application method, and then dried for 1 hour at 90° C., to obtain the photoreceptor.

### Experimental Examples 1 Through 7

As indicated in Table 1 below, various layered-type positive-charging OPCs were fabricated, with the amount of charge generation material added in the charge generation layer varied from 0.7 wt % to 4 wt %, for use in experimental examples 1 through 7. The layered-type positive-charging OPCs with charge generation material added amounts of 1 wt %, 1.5 wt %, 2 wt %, and 2.5 wt % added were experimental examples 2 through 5 of the invention. In the experimental examples, the film thickness of the charge transport layer was set to 3 μm, 5 μm, 10 μm, 15 μm, 20 μm, 25 μm, and 30 μm, and photoreceptors were fabricated with the total film thickness together with the charge generationt layer held constant at 30 μm.

These photoreceptors were installed in a Brother Industries model “HL5240” 1200 DPI high-resolution printer, employing a nonmagnetic single-component contact development cleanerless process using a suspension polymerized toner at 30 ppm (A4 equivalent), and the exposed portion potential was measured. Results obtained are shown in Table 1 below and in FIG. 3.

TABLE 1

| | Charge generation layer film thickness | | | | | | | Performance | |
|---|---|---|---|---|---|---|---|---|---|
| | (μm) | | | | | | | Interference | Sensitivity |
| | 3 | 5 | 10 | 15 | 20 | 25 | 30 | fringes | control |
| Experimental | 530 | 390 | 250 | 210 | 200 | 195 | 190 | did not occur | good |
| example | | | | | | | | | |
| 1 (CGM 0.7 wt | | | | | | | | | |
| %) | | | | | | | | | |
| Experimental | 420 | 300 | 200 | 170 | 160 | 155 | 150 | occurred | good |
| example | | | | | | | | | |
| 2 (CGM 1 wt | | | | | | | | | |
| %) | | | | | | | | | |
| Experimental | 330 | 235 | 150 | 125 | 120 | 115 | 110 | occurred | good |
| example | | | | | | | | | |
| 3 (CGM 1.5 wt | | | | | | | | | |
| %) | | | | | | | | | |
| Experimental | 250 | 160 | 120 | 115 | 115 | 100 | 100 | occurred | good |
| example | | | | | | | | | |
| 4 (CGM 2 wt | | | | | | | | | |
| %) | | | | | | | | | |
| Experimental | 180 | 130 | 110 | 105 | 100 | 100 | 100 | occurred | good |
| example | | | | | | | | | |
| 5 (CGM 2.5 wt | | | | | | | | | |
| %) | | | | | | | | | |
| Experimental | 130 | 110 | 85 | 95 | 105 | 105 | 110 | occurred | fair |
| example | | | | | | | | | |
| 6 (CGM 3 wt | | | | | | | | | |
| %) | | | | | | | | | |
| Experimental | 100 | 80 | 80 | 95 | 110 | 115 | 120 | occurred | poor |
| example | | | | | | | | | |
| 7 (CGM 4 wt | | | | | | | | | |
| %) | | | | | | | | | |

Experimental example 1, in which the charge generation material is at 0.7 wt %, tends to have high exposed portion potentials and insufficient sensitivity, and in addition interference fringes readily occurred when the charge generation layer film thickness was 5 μm, and the results were unfavorable. On the other hand, in experimental examples 6 and 7 with charge generation material at 3 wt % and higher, with the film thickness increase portion in the charge generation layer at 10 μm and above, the exposed portion potential tended to rise rather than fall, and it is seen that sensitivity control through control of the charge generation layer film thickness is difficult. Experimental examples 2 through 5, in which the charge generation material is at 1 wt % to 2.5 wt %, were favorable with respect to the overall sensitivity level as well as sensitivity control.

In the region of charge generation layer film thicknesses at and below 5 μm, the amount of increase in exposed portion potential per 1 μm reduction in film thickness was high at 60 V for charge generation material at 1 wt %, and at 25 V for 2.5 wt %; the amount of fluctuation in the exposed portion potential due to decreases in the film with wear were large, and practical use was not possible. At charge generation layer film thicknesses of 20 μm and above, the amount of change in the exposed portion potential per film thickness of the charge generation layer changed hardly at all at 25 μm and above in particular. Hence the range of charge generation layer film thicknesses from 5 to 25 μm is seen to be appropriate for sensitivity control.

In these devices, satisfactory dot reproducibility and grayscale performed were confirmed for samples of experimental example 4 with charge generation layers of thickness 10 μm, but devices with low light quantities and fast devices can be accommodated by increasing the film thickness of the charge generation layer. On the other hand, in devices with large light quantities and slow devices, lower sensitivities can be accommodated by lowering the film thickness of the charge generation layer. In this way, when the film thickness of the charge generation layer is 10 μm or less, it is preferable that use be in a nonmagnetic single-component contact development cleanerless process device using a suspension polymerized toner, for which the film reduction due to repeated use is 2 μm or less. By means of this invention, by providing a charge generation layer with durability as the uppermost surface layer, there is no longer a need to provide a special surface protective layer, as in layered-type positive-charging OPCs of the prior art. As a result, satisfactory environmental stability, repetition stability, and durability can be achieved, and in addition a positive-charging OPC capable of optimal sensitivity characteristics for different devices can be obtained. High-resolution images with excellent dot reproducibility and grayscale characteristics inherent in positive-charging OPCs can be obtained with stability and in addition the same liquids of this invention can be used, changing the film thickness of the charge generation layer, to secure compatibility with a device.

1. A positive charging electrophotography photoreceptor comprising:
a laminated structure that includes a conductive supporting member, a charge generation layer, and a charge transport layer between the charge generation layer and the conductive supporting member,
wherein the charge transport layer includes a hole transport material and a first resin binder, and
wherein the charge generation layer includes a charge generation material, a hole transport material, an electron transport material, and a second resin binder, the content of the charge generation material in the charge generation layer being in the range exceeding 0.7 wt % and less than 3.0 wt % of the charge generation layer.

2. The electrophotography photoreceptor according to claim 1, wherein the charge generation layer serves as an uppermost surface layer of the laminated structure, without a surface protective layer.

3. The electrophotography photoreceptor according to claim 1, wherein the second binder resin content in the charge generation layer is from 40 wt % to 70 wt %.

4. The electrophotography photoreceptor according to claim 2, wherein the second binder resin content in the charge generation layer is from 40 wt % to 70 wt %.

5. The electrophotography photoreceptor according to claim 1, wherein the first binder resin content in the charge transport layer is from 40 wt % to 60 wt %.

6. The electrophotography photoreceptor according to claim 2, wherein the first binder resin content in the charge transport layer is from 40 wt % to 60 wt %.

7. The electrophotography photoreceptor according to claim 1, wherein the first binder resin is polystyrene.

8. The electrophotography photoreceptor according to claim 2, wherein the first binder resin is polystyrene.

9. A method of manufacturing a positive-charging electrophotography photoreceptor that includes a laminated structure having a conductive supporting member, a charge transport layer formed of at least a hole transport material and a first binder resin, and a charge generation layer formed of at least a charge generation material, a hole transport material, an electron transport material, and a second binder resin, the charge transport layer being disposed between the conductive supporting member and the charge generation layer, said method comprising:
setting the content of the charge generation material in the charge generation layer in a range exceeding 0.7 wt % and less than 3.0 wt % of the charge generation layer, and
setting a desired sensitivity by changing a ratio of the thickness of the charge transport layer to the thickness of the charge generation layer.

10. The method of manufacturing an electrophotography photoreceptor according to claim 9, wherein the first binder resin of the charge transport layer is polystyrene, and the charge generation layer is fabricated on the charge transport layer by an immersion application method.

11. An electrophotography device, comprising the electrophotography photoreceptor according to claim 1.

12. The electrophotography device according to claim 11, wherein a nonmagnetic single-component contact development cleanerless process is employed in the electrophotography device using a positive polymerized toner.
